(19) United States
(12) Patent Application Publication
(10) Pub. No.: US 2002/0067966 A1
(43) Pub. Date: Jun. 6, 2002

(54) Method of forming milled tooth of variable tooth worm

(76) Inventors: Yaxiong Zhang, Tianjin (CN); Lin Qi, Tianjin (CN)

Correspondence Address: Karl F. Milde, Jr., Esq., MILDE, HOFFBERG & MACKLIN, L.L.P., Suite 460, 10 Bank Street, WHITE PLAINS, NY, 10606, US

(21) Appl. No.: 09/978,340

(22) Filed: Oct. 17, 2001

(30) Foreign Application Priority Data
Dec. 1, 2000 (CN) 00133681.9

(51) Int. Cl. B23F 5/00

(52) U.S. Cl. 409/48

(57) ABSTRACT

A method of forming milled tooth of variable tooth worm (VTW),comprising: coupling a workpiece of worm with a coordinate system {σ₁(φ₁)[O₁; \overline{i}₁(φ₁), \overline{j}₁(φ₁), \overline{k}₁(φ₁)]} on the CNC multi-axes simultaneously coupled machine tool, in which the workpiece of worm is rotated with the angular speed ω₁ around the axis of \overline{k}₁(φ₁); coupling a milling-cutter with another coordinate system {σ₂(φ₂)[O₂; \overline{i}₂(φ₂), \overline{j}₂(φ₂), \overline{k}₂(φ₂)]} on the CNC multi-axes simultaneously coupled machine tool, in which the milling-cutter is rotated with angular speed ω₂ around the axis of \overline{k}₂(φ₂), and ω₁/ω₂=i and i is constant; feeding the milling-cutter to move along \overline{i}₂(O₂) axis in the radial direction and simultaneously rotate around \overline{k}₂(φ₂) in the circumference direction, the coordinates of edge of milling-cutter is according to the following equations: X₂=u, Y₂=r_{b}−ν sin β, Z₂=ν cos β.

### FIELD OF THE INVENTION

This invention relates to a method of forming milled tooth of cylindrical variable tooth worm.

### BACKGROUND OF THE INVENTION

The worm transmissions are divided into two main groups: the first group is cylindrical worm transmission, the second group is toroidal worm transmission. The cylindrical worms are classified as involute helicoids worm (hereinafter “ZI”), Archimedes worm (hereinafter “ZA”), K type worm (hereinafter “ZK”), and variable tooth worm (hereinafter “VTW”) published in Chinese patent No. ZL96244108.2, according to the different profile line. These cylindrical worms were formed by lathe turning with straight edge cutter. The forming of these worms are distinguished in cutting mounting position of the straight edge cutter. However, the relative movement between the work-piece and the cutter is same. In the other word, only by means of changing the mounting position of straight edge cutter on the same machine tool, the different type worms such as ZI, ZA and ZK can be formed through the work-piece turning and the milling-cutter feeding along the axial and radial directions. Although the variable tooth worm (VTW) is a kind of the cylindrical worm, the variable tooth worm (VTW) can not be formed by means of above-mentioned ways and means. The reasons thereof are that tooth profile of the variable tooth worm thread is changing along the direction both tooth width and tooth height, the minimum tooth width of the worm is at the middle part along the tooth thread length while it gradually increased to both ends, as shown in the FIGS. 1 and 2.

### SUMMARY OF THE INVENTION

The object of the invention is to overcome the shortcomings in the prior art and provides a method of forming milled tooth of variable tooth worm (VTW) with high-efficiency and high-accuracy.

In view of the object, the invention provides a method of forming milling tooth for VTW comprising following steps: coupling a work-piece of worm with a coordinate system {σ₁(φ₁) [O₁; \overline{i}₁(φ₁), \overline{j}₁(φ₁), \overline{k}₁(φ₁)]} on the CNC multi-axes simultaneously coupled machine tool, in which the work-piece of worm is rotated at angular speed ω₁ around the axis of \overline{k}₁ (φ₁); coupling a milling-cutter with another coordinate system {σ₂(φ₂) [O₂; \overline{i}₂(φ₂), \overline{j}₂(φ₂), \overline{k}₂(φ₂)]} on the CNC multi-axes simultaneously coupled machine tool, in which the milling-cutter is rotated at angular speed ω₂ around the axis of \overline{k}₂(φ₂), ω₁/ω₂=i and i is constant; feeding the milling-cutter to move along \overline{i}₂(O₂) axis in the radial direction while simultaneously rotate around \overline{k}₁(φ₂) in the circumference direction, the coordinates of a point of edge of milling-cutter is according to the following equations:

X₂=u

Y₂=r_{b}−^{v} sin β

Z₂=^{v} cos β

In which u and ν are parameter of generatrix surface of edge, β is inclined angle of generatnx surface, r_{b} is the radius of main basic circumference of milling-cutter body, X₂, Y₂, Z₂ are coordinates of a point of edge of milling-cutter in the generatrix surface.

The advantages and effect of the invention are as following: the VTW is formed by a spatial milling-cutter that has multi-group cutters on the milling-cutter body and simultaneously achieves feeding motion, the method of the invention has higher efficiency to form the worms than any other various method in the prior art, and have the advantages of more cutting power, less consume time and higher accuracy of formed VTW.

### BRIEF DESCRIPTION OF THE DRAWING

FIGS. 1 and 2 are the schematic view of the VTW worm and coordinate system of the prior art of Chinese patent No. ZL96244108.2;

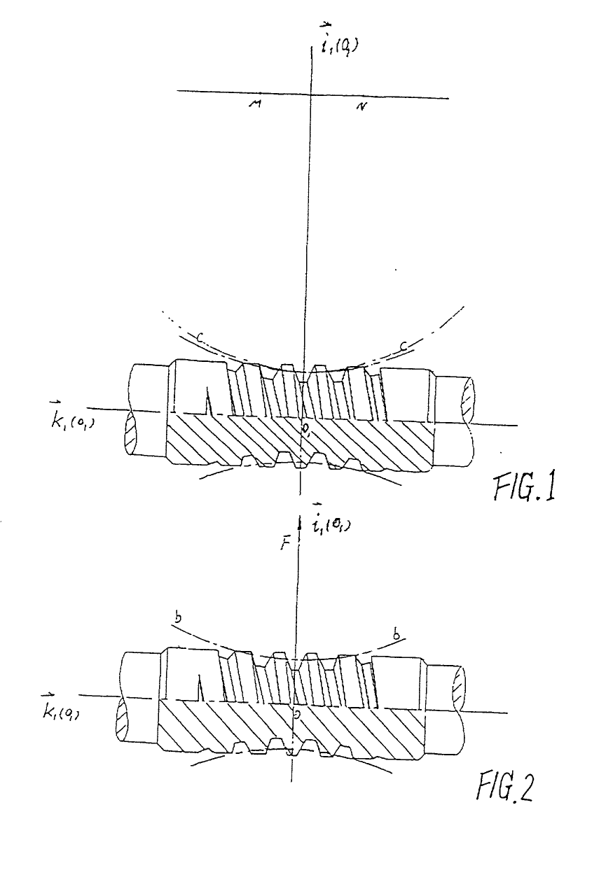

FIG. 3 is a schematic view for the illustration of the method of the invention, showing the relative coordinate relationship between a work-piece of the worm and milling-cutter on the coordinate system.

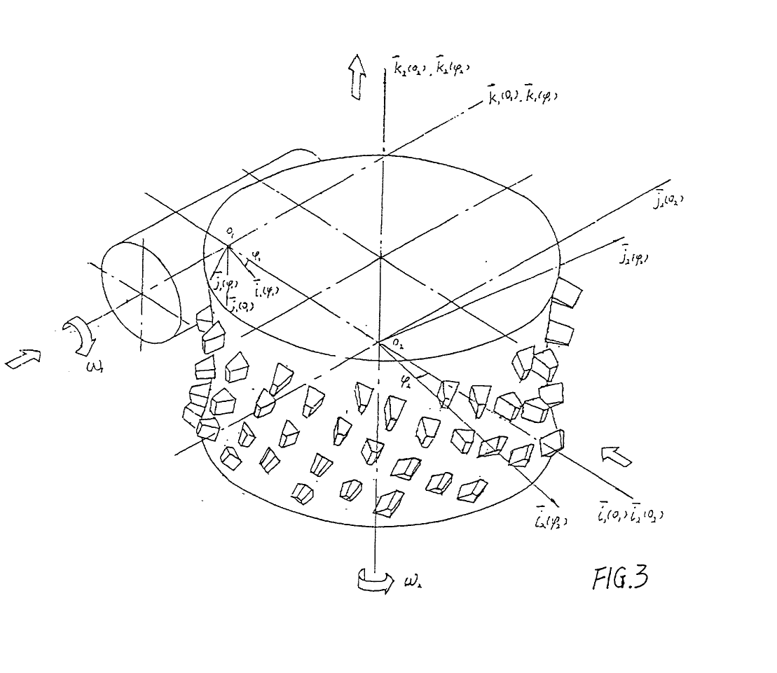

### DETAILED DESCRIPTION OF THE PREFERRED EMBODIMENTS

The detailed explanations of the method of the invention are given by following preferred embodiments.

Embodiment 1:

On a CNC 5-coupled-axes machine-tool, given than generetrix surface is inclined a angle β and β=18°, reference diameter of VTW is d₁=50.2 mm, center distance between a work-piece and milling-cutter a=101.6 mm, the milling-cutter performs a cutting movement in relation to the work-piece, transmission ratio between the worm and milling-cutter relation motion i=41/4; the work-piece is rotated around the axis of \overline{k}₁(φ₁) while the milling-cutter is rotated in an angular speed ω₂ about the axis of \overline{k}₂(φ₂) and achieves a circumferential feeding about \overline{k}₂(φ₂) and radial feeding simultaneously along \overline{i}₂(O₂), basic circle radius of the milling-cutter r_{b}=33 mm and the coordinates point of milling-cutter edge are described according to the following equations X₂=u, Y₂=r_{b}−ν sin β=33−v sin 18°,Z₂=ν cos β=ν cos 18°; all cutter are three dimensionally amounted on the milling-cutter body and the cutting edges are located at a spatial surface series, the CNC 5-coupled-axes machine tool is adjusted based on the above mention parameter, and the VTW is formed by the machine tool.

Embodiment 2:

on a CNC 5 coupled-axes machine tool, given that inclined angle of generetrix surface β=18°, reference diameter of d₁=50.2 mm, center distance between VTW and milling-cutter a=101.6 mm; the milling-cutter performs a cutting movement in relation to the work-piece, transmission ratio i=41/4. Besides the rotation around \overline{k}₁(φ₁), the work-piece moves a slight displacement Δk₁=1.05 mm along the axis of \overline{k}₁(φ₁) axis in order to form an ellipse or parabola reference circular of VTW.

The milling-cutter is rotated at an angular speed ω₂ about the axis of \overline{k}₂(φ₂) and achieves a circumferential feeding about \overline{k}₂(φ₂) and radial feeding along \overline{i}₂(O₂) simultaneously; main basic circle radius of the milling-cutter r_{b}=33 mm and the coordinates point of milling-cutter edge are described according to the following equations X₂=u, Y₂=r_{b}−ν sin β=33−v sin 18°,Z₂=ν cos β=ν cos 18°; all cutter are three dimensionally amounted on the milling-cutter body and the cutting edges are located at a spatial surface series, the machine tool is adjusted according to the above mention parameter and the VTW is formed by the machine tool.

Embodiment 3:

on a CNC 5 couple-axes machine, given that inclined angle in generatrix surface β=15.90°, reference diameter of VTW d₁=50 mm, center distance between worm gear and workpiece a=125 mm; the milling-cutter performs a cutting movement in relation to the work-piece, transmission ratio i=42/3.

Besides the rotation around \overline{k}₁(φ₁), the work-piece moves a slight displacement Δ k₁=1.1 mm along the axis of \overline{k}₁(φ₁) in order to form an ellipse or parabola reference circular of VTW.

Besides the rotation around the axis of \overline{k}₂(φ₂), circumferential feeding about \overline{k}₂(φ₂) and radial feeding along the axis of \overline{i}₂(O₂), the milling-cutter performs a slight displacement Δk₂=1.3 mm along the axis of \overline{k}₂(φ₂) and the differential tangential feeding around the axis of \overline{k}₂(φ₂), i.e., the feeding movement of the milling-cutter is the combination of displacement movements along \overline{i}₁(φ₂) and \overline{k}₂(φ₂) direction and tangent differential feeding around the axis of \overline{k}₂(φ₂), such that making milling-cutter enveloping motion achieve more complete effect.

The basic circle radius of the milling-cutter r_{b}=33 mm and the coordinates point of milling-cutter edge are described according to the following equations X₂=u, Y₂=r_{b}−84 sin β=33−ν sin 18°, Z₂=ν cos β=ν cos 18°; all cutter are three dimensionally amounted on the milling-cutter body and the cutting edges are located at a spatial surface series, the machine tool is adjusted according to the above mention parameter and the VTW is formed by the machine tool.

What is claimed is:

1. A method of forming milled tooth of variable tooth worm, comprising following steps:
coupling a work-piece of worm with the coordinate system {σ₁[O₁; \overline{i}₁(φ₁), \overline{j}₁(φ₁), \overline{k}₁(φ₁)]} on a CNC multi-axes simultaneously coupled machine tool, in which the work-piece of worm is rotated at angular speed ω₁ around the axis of \overline{k}₁(φ₁);
coupling a milling-cutter with the coordinate system {σ₂(φ₂)[O₂; \overline{i}₂(φ₂) \overline{j}₂(φ₂), \overline{k}₂(φ₂)]} on the CNC multi-axes simultaneously coupled machine tool, in which the milling-cutter is rotated at angular speed ω₂ around the axis of \overline{k}₂(φ₂), ω₁/ω₂=i and i is constant; feeding the milling-cutter to move along the axis of \overline{i}₂(O₂) in the radial direction while simultaneously rotate around \overline{k}₂(φ₂) in the circumference direction, the coordinates of edge of milling-cutter is according to the following equations:
X₂=u
Y₂=r_{b}−ν sin β
Z₂=ν cos β
in which u and ν are parameter of generatrix surface of edge, β is inclined angle of generatnx surface, r_{b} is the radius of main basic circumference of milling-cutter body, X₂, Y₂, Z₂ are coordinates of a point of edge of milling-cutter in the generatrix surface.

2. The method as described in the claim 1, wherein the work-piece moves a slight displacement along the axis of \overline{k}₁(φ₁) direction.

3. The method as described in the claim 1 or claim 2, wherein the milling-cutter moves a slight displacement along the axis of \overline{k}₂(φ₂) direction while simultaneously performs tangent differential feeding around the axis of \overline{k}₂(φ₂).
